(19) United States
(12) Patent Application Publication
(10) Pub. No.: US 2024/0162445 A1
(43) Pub. Date: May 16, 2024

(54) BINDER FOR ELECTRODE, NEGATIVE ELECTRODE FOR SECONDARY BATTERY INCLUDING THE BINDER, AND LITHIUM SECONDARY BATTERY

(71) Applicants: Hyundai Motor Company, Seoul (KR); Kia Corporation, Seoul (KR)

(72) Inventors: Dong Jun Kim, Seongnam-Si (KR); Young Woo Lee, Seongnam-Si (KR); Soo Youn Park, Anyang-Si (KR); Jin Su Yoon, Gimcheon-Si (KR); Shin Kook Kong, Suwon-Si (KR); Jin Hee Lee, Gunpo-Si (KR)

(21) Appl. No.: 18/369,955

(22) Filed: Sep. 19, 2023

(30) Foreign Application Priority Data
Nov. 3, 2022 (KR) 10-2022-0145269

(51) Int. Cl. H01M 4/62; C08F 279/02; H01M 4/13

(52) U.S. Cl. CPC H01M 4/623; C08F 279/02; H01M 4/13; H01M 2004/027

(57) ABSTRACT

Provided are a binder for an electrode, a negative electrode for a secondary battery including the binder, and a secondary battery, in which an active material layer is prevented from lifting from a negative electrode base material. A binder forming an electrode of a secondary battery includes a binder particle and a temperature-sensitive polymer grafted on a surface of the binder particle.

### CROSS REFERENCE TO RELATED APPLICATION

The present application claims priority to Korean Patent Application No. 10-2022-0145269, filed Nov. 3, 2022, the entire contents of which is incorporated herein for all purposes by this reference.

### BACKGROUND

### Field

The present disclosure relates to a binder for an electrode, a negative electrode for a secondary battery including the binder, and a lithium secondary battery.

### Discussion of the Background

Secondary batteries may be used as small high-performance energy sources for large-volume power storage batteries such as electric vehicles, battery power storage systems, etc., and portable electronic devices such as mobile phones, camcorders, laptop computers, etc. For miniaturization of portable electronic devices and continuous use thereof for a long time, there is a need for a secondary battery capable of realizing a small size and high capacity along with research on weight reduction and low power consumption of parts.

In particular, a lithium secondary battery that is one type of secondary batteries has higher energy density, larger capacity per area, lower self-discharge rate, and longer lifetime than a nickel manganese battery or a nickel cadmium battery. Because of no memory effect, characteristics of convenience in use and long lifetime may be provided.

For a lithium secondary battery, electric energy is produced by oxidation and reduction reactions when lithium ions are intercalated/deintercalated in a cathode and an anode in a state where an electrolyte is charged between the cathode and the anode that are composed of active materials into and from which the lithium ions may be intercalated and deintercalated.

Such a lithium secondary battery includes a positive electrode, an electrolyte, a separator, a negative electrode, etc., and it may be important to stably maintain an interfacial reaction between components so as to ensure long lifetime and reliability of the lithium secondary battery.

These lithium secondary batteries may be manufactured by using a lithium-intercalated compound such as LiCoO₂, LiMn₂O₄, etc., for positive electrodes and using a non-lithium-intercalated material such as carbon or Si-based lithium for negative electrodes, in which lithium ions inserted into the positive electrode move to the negative electrode through an electrolyte during charge, and the lithium ions move from the negative electrode to the positive electrode during discharge.

Each of the positive electrode and the negative electrode may be manufactured by mixing an active material, a conductive material, a binder, and a functional additive into a solvent to provide a slurry, coating the provided slurry onto a base material, drying the same, and forming an active material layer.

In this case, the binder may bond respective materials and form an adhesive force with the base material.

However, the binders move toward the surface along the solvent as the solvent evaporates to the surface of the active material layer in a process of coating the slurry onto the base material and drying the same.

As the binder moves toward the surface of the active material layer, the amount of the binder in an adhesive portion with the base material decreases and an adhesive force with the base material degrades, and moreover, as the amount of the binder on the surface of the active layer increases, the binder lifts from the surface of the active material layer, deteriorating the characteristics of the electrode.

To solve this problem, a method of double-coating an upper portion and a lower portion of the active material layer with different compositions or methods of coating a primer before coating a slurry to a base material may be used.

However, these methods have the disadvantage of increasing the number of processes for producing electrodes and having to prepare and apply slurries by type.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

The present disclosure is proposed to solve these problems and aims to provide a binder for an electrode, a negative electrode for a secondary battery including the binder, and a lithium secondary battery in which a bonding force between materials forming an active material layer may be increased while firmly bonding the active material layer to a negative electrode base material. A binder for an electrode, a negative electrode for a secondary battery including the binder, and/or a lithium secondary battery may have an active material layer that is prevented from lifting from a negative electrode base material.

Technical problems to be solved in the present disclosure are not limited to the above-mentioned technical problems, and other unmentioned technical problems may be clearly understood by those skilled in the art.

A binder forming an electrode of a secondary battery may comprise: a binder particle; and a temperature-sensitive polymer grafted on a surface of the binder particle.

The binder particle may comprise styrene-butadiene rubber (SBR), and the temperature-sensitive polymer may comprise poly-N-isopropylacrylamide.

At a lower critical solution temperature (LCST), hydrophilicity of the temperature-sensitive polymer becomes lower and a shape of a polymer chain of the temperature-sensitive polymer shrinks.

The LCST of the temperature-sensitive polymer may be a temperature in a range of 30° C. to 80° C.

The LCST of the temperature-sensitive polymer may be a temperature in a range of 30° C. to 40° C.

A particle size of the binder particle may be in a range of 100 nm to 300 nm.

A negative electrode for a secondary battery may comprise: a negative electrode base material; and an active material layer coated on at least one surface of the negative electrode base material, wherein the active material layer comprises a binder comprising: a binder particle; and a temperature-sensitive polymer grafted on a surface of the binder particle.

The active material layer may comprise a negative electrode active material, a conductive material, and a functional additive, and the binder may be contained at 0.5 to 5 wt % with respect to a total weight of the active material layer.

The binder particle may comprise styrene-butadiene rubber (SBR), and the temperature-sensitive polymer may comprise poly-N-isopropylacrylamide.

At a lower critical solution temperature (LCST), a shape of a polymer chain of the temperature-sensitive polymer shrinks; a bonding force between the negative electrode active material of the active material layer and a conductive material of the active material layer increases; and a bonding force between the active material layer and the negative electrode base material increases.

A secondary battery may comprise: a positive electrode; a separator; an electrolyte; and a negative electrode comprising: a negative electrode base material; and an active material layer coated on at least one surface of the negative electrode base material, wherein the active material layer comprises a binder comprising: a binder particle; and a temperature-sensitive polymer grafted on a surface of the binder particle.

The active material layer may comprise a negative electrode active material, a conductive material, and a functional additive, and the binder is contained at 0.5 to 5 wt % with respect to a total weight of the active material layer.

The binder particle may comprise styrene-butadiene rubber (SBR), and the temperature-sensitive polymer may comprise poly-N-isopropylacrylamide.

At a lower critical solution temperature (LCST), a shape of a polymer chain of the temperature-sensitive polymer shrinks; a bonding force between a negative electrode active material of the active material layer and a conductive material of the active material layer increases; and a bonding force between the active material layer and the negative electrode base material increases.

By grafting the temperature-sensitive polymer capable of improving a bonding force with other materials while having the polymer chain that changes with a temperature on the surface of the binder particle constituting the binder, the binder may be suppressed from lifting in the process of coating the slurry forming the active material layer on the base material forming the electrode or the process of drying the slurry.

As the temperature-sensitive polymer is grafted on the binder, the adhesive strength between the active material layer and the base material may be improved when the active material layer is coated on the base material.

These and other features and advantages are described in greater detail below.

### BRIEF DESCRIPTION OF THE DRAWINGS

FIG. 1 shows a cross-section of a negative electrode for a secondary battery; and

FIG. 2 shows a change in shape of a polymer chain with respect to a temperature of a binder for an electrode.

### DETAILED DESCRIPTION

Hereinafter, various examples will be described in detail with reference to the accompanying drawings, and regardless of figure symbols, the same component or similar components will be given the same reference numeral and a redundant description will not be provided.

A detailed description of related well-known techniques may be omitted if it obscures the subject matter of the disclosure. The accompanying drawings are only for understanding of the examples disclosed herein, and it should be understood that the technical spirit disclosed herein is not limited by the accompanying drawings and all changes, equivalents, and substitutes included in the spirit and scope of the present disclosure are included.

Although ordinal numbers such as “first”, “second”, and so forth will be used to describe various components of the present disclosure, those components are not limited by the terms. These terms may be used for the purpose of distinguishing one component from another component.

Singular forms include plural forms unless apparently indicated otherwise contextually.

It will be further understood that the terms “comprises” and/or “has,” when used in this specification, specify the presence of a stated feature, number, step, operation, component, element, or combination thereof, but do not preclude the presence or addition of one or more other features, numbers, steps, operations, components, elements, or combinations thereof.

A lithium secondary battery may include a configuration of a general lithium secondary battery. For example, the lithium secondary battery may include a positive electrode, a negative electrode, a separator, and an electrolyte which for a general lithium secondary battery. However, in one or more examples described herein, the negative electrode may be characterized in that a temperature-sensitive polymer is grafted on a binder forming an active material layer.

A positive electrode may be formed by coating a positive active material layer onto both surfaces of a positive electrode base material, e.g., a positive electrode current collector.

Herein, the positive electrode current collector may include any material as long as it is a conductor and is electrochemically stable within the range of use, for example, aluminum, stainless steel, nickel-plated steel, etc.

The positive electrode active material layer may be a layer formed on both surfaces of the positive electrode current collector, and may be formed by mixing the positive electrode active material, the conductive material, and the binder. Herein, the positive electrode active material may be formed of a solid solution oxide containing lithium, and without being limited thereto, may not be particularly limited as long as it may electrochemically occlude and release lithium ions. The positive cathode active material layer may include a functional additive for adding various functions. For example, as the functional additive, a thickener, etc., may be used.

The conductive material may be used to give conductivity to the cathode, and any electronic conductive material may be used in a configured battery as long as it does not cause a chemical change, and for example, natural graphite, artificial graphite, carbon black, acetylene black, ketjen black, carbon fiber, metal powder such as copper, nickel, aluminum, silver, etc., metal fiber, or the like may be used, and one type of conductive materials such as polyphenylene derivatives or a combination of one or more types may be used. For example, carbon black may be used as a conductive material.

The binder may serve to attach particles of respective cathode active materials well to each other or to a current collector, and for example, polyvinyl alcohol, carboxymethyl cellulose (CMC), hydroxypropyl cellulose, diacetyl cellulose, polyvinyl chloride, carboxylated polyvinyl chloride, polyvinylidene fluoride, polymer containing ethylene oxide, polyvinylpyrrolidone, polyurethane, polytetrafluoroethylene, polyvinylidene fluoride, polyethylene, polypropylene, styrene-butadiene rubber (SBR), acrylated styrene-butadiene rubber, epoxy resin, nylon, etc., may be used, without being limited thereto. For example, polyvinylidene fluoride (PVDF) may be used as the binder. The binder may be formed by grafting a temperature-sensitive polymer onto the surface of the binder particle.

The separation film may prevent short-circuit between an anode and a cathode, and provide a moving path of Li ions. As the separation film, a known film may be used. The separation film may include a polyolefin-based polymer film such as polypropylene, polyethylene, polyethylene/polypropylene, polyethylene/polypropylene/polyethylene, polypropylene/polyethylene/polypropylene, or a multilayer thereof, a microporous film, woven fabrics and non-woven fabrics. A film made of coating resin having high safety onto a porous polyolefin film may be used.

The electrolyte may include Li salt and a solvent. The electrolyte may include (e.g., contain) a functional additive for adding various functions.

As Li salt, one or a mixture of two or more selected from a group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N, LiFSI, and (CF₃SO₂)₂NLi may be used.

As the solvent, one or a mixture of two or more selected from a group consisting of a carbonate-based solvent, an ester-based solvent, an ether-based solvent, or a ketone-based solvent may be used.

As the carbonate-based solvent, dimethyl carbonate (DMC), diethyl carbonate (DEC), dipropyl carbonate (DPC), methylpropyl carbonate (MPC), ethylpropyl carbonate (EPC), ethylmethyl carbonate (EMC), and ethylene carbonate (EC), propylene carbonate (PC), butylene carbonate (BC), fluoroethylene carbonate (FEC), vinylene carbonate (VC), etc. may be used. As the ester-based solvent, γ-butyrolactone (GBL), n-methyl acetate, n-ethyl acetate, n-propyl acetate, etc. may be used, and as the ether-based solvent, dibutyl ether, etc. may be used, without being limited thereto.

The solvent may include an aromatic hydrocarbon-based organic solvent. Detailed examples of the aromatic hydrocarbon-based organic solvent may include benzene, fluorobenzene, bromobenzene, chlorobenzene, cyclohexylbenzene, isopropylbenzene, n-butylbenzene, octylbenzene, toluene, xylene, mesitylene, etc., and may be used alone or in combination.

The functional additive may serve to stabilize the positive electrode or the negative electrode by forming solid electrolyte interphase (SEI) on the surface of the positive electrode or the negative electrode. For example, as the functional additive, vinylene carbonate (VC) may be used.

The negative electrode, like the positive electrode, may be formed by coating the negative electrode active material layer on the both surfaces of the negative electrode base material, e.g., the negative electrode current collector.

In one or more examples, the negative electrode active material layer forming the negative electrode may include a binder in which a temperature-sensitive polymer is grafted on the surface of the binder particle.

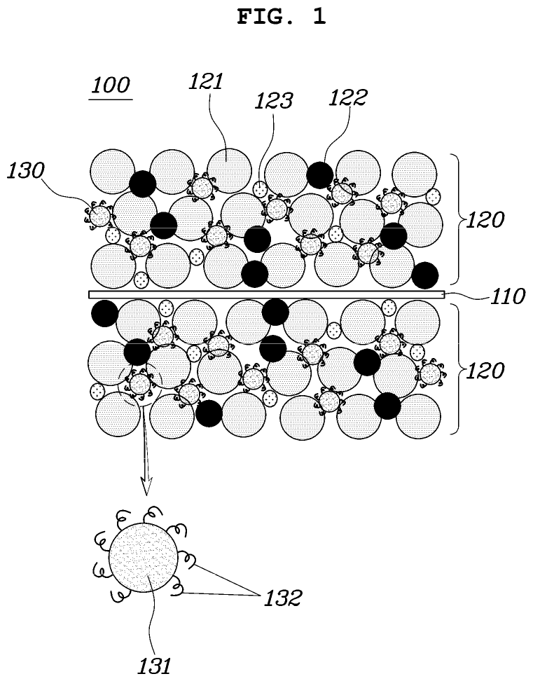

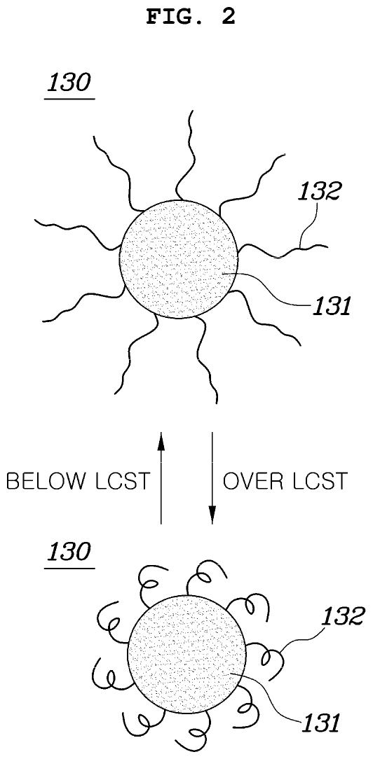

FIG. 1 shows a cross-section of a negative electrode for a secondary battery. FIG. 2 shows a change in shape of a polymer chain with respect to a temperature of a binder for an electrode. As shown in FIG. 1, a negative electrode 100 may include a negative electrode base material 110 and a negative electrode active material layer 120 coated on at least any one of both surfaces of the negative electrode base material 110. The negative electrode active material layer 120 may include a binder 130 in which a temperature-sensitive polymer 132 is grafted on the surface of a binder particle 131.

The negative electrode base material 110 may be a conductor serving as a negative electrode current collector, and may use any material as long as it is electrochemically stable within the range of use, for example, a conductive material such as copper or nickel in the form of a foil.

The negative electrode active material layer 120 may be a layer formed on both surfaces of the negative electrode current collector, and may be formed by mixing a negative electrode active material 121, a conductive material 122, and the binder 130. Herein, as the negative electrode active material 121, materials such as natural graphite, artificial graphite, low crystalline carbon, silicon oxide, and silicon carbide may be used. The negative electrode active material layer 120 may include a functional additive 123 for adding various functions. For example, as the functional additive 123, a thickener, etc., may be used.

The conductive material 122 may be used to provide conductivity to the cathode like a conductive material applied to the positive electrode, and any electronic conductive material may be used in a configured battery as long as it does not cause a chemical change, and for example, natural graphite, artificial graphite, carbon black, acetylene black, ketjen black, carbon fiber, metal powder such as copper, nickel, aluminum, silver, etc., metal fiber, or the like may be used, and one type of conductive materials such as polyphenylene derivatives or a combination of one or more types may be used. For example, carbon black may be used as a conductive material.

As the binder 130 applied to the negative electrode 100, one formed by grafting the temperature-sensitive polymer 132 on the surface of the binder particle 131 may be used.

The binder 130 may include the binder particle 131 and the temperature-sensitive polymer 132 grafted on the surface of the binder particle 131.

As the binder particle 131, polyvinyl alcohol, carboxymethyl cellulose (CMC), hydroxypropyl cellulose, diacetyl cellulose, polyvinyl chloride, carboxylated polyvinyl chloride, polyvinylidene fluoride, polymer containing ethylene oxide, polyvinylpyrrolidone, polyurethane, polytetrafluoroethylene, polyvinylidene fluoride, polyethylene, polypropylene, styrene-butadiene rubber (SBR), acrylated styrene-butadiene rubber, epoxy resin, nylon, etc., may be used. In at least some implementations, it may be desirable to use SBR as the binder particle 131 considering the grafting efficiency of the temperature-sensitive polymer 132.

A particle size of the binder particle 131 may be maintained between 100 nm to 300 nm to facilitate grafting of the temperature-sensitive polymer 132 and suppress lifting of the negative electrode active material layer 120.

If the particle size of the binder particle 131 is less than a proposed range, the amount of the temperature-sensitive polymer 132 grafted on the surface of the binder particle 131 may decrease excessively, such that the effect of grafting of the temperature-sensitive polymer 132 is small, whereas if the particle size of the binder particle 131 is greater than the proposed range, it may be difficult to synthesize the binder particle and the performance of binding with the negative electrode active material 121, the conductive material 122, the functional additive 123, and the negative electrode base material 110 is degraded.

The temperature-sensitive polymer 132 grafted on the surface of the binder particle 131 may be characterized in that hydrophilicity thereof becomes lower and a shape of a polymer chain shrinks, at a lower critical solution temperature (LCST) and/or over than at a temperature below the LCST.

Consequently, as shown in FIG. 2, in a state in which a slurry for forming the negative electrode active material layer 120 is coated on the negative electrode base material 110 to manufacture the negative electrode 100, the chain of the temperature-sensitive polymer 132 may maintain an unshrunk form. But if an ambient temperature increases to the LCST or higher in the process of drying the slurry, the chain of the temperature-sensitive polymer 132 shrinks and thus the shape is changed. Thus, a binding force between the negative electrode active material 121 and the conductive material 122 around the binder 130 increases, such that a solvent moves to the surface of the negative electrode active material layer 120 and evaporates, thus preventing the negative electrode active material layer 120 from lifting.

Likewise, as the ambient temperature increases in the process of drying the slurry, the chain of the temperature-sensitive polymer 132 shrinks and thus the shape is changed, the temperature-sensitive polymer 132 may act as a contact point of a physical gel between the binder particles 131 to gelate a part of the binder 130, and such gelation of the part of the binder 130 results in the viscosity of the slurry to be dramatically increased, thereby suppressing the negative electrode active material layer 120 from lifting.

The LCST for the temperature-sensitive polymer 132 may be 30° C. to 80° C. based on coating of the slurry and the atmospheric temperature in the drying process. In at least some implementations, it may be preferable that the LCST may be 30° C. to 40° C.

As the temperature-sensitive polymer 132, poly(N-isopropylacrylamide) expressed as [Chemical Formula 1] may be applied.

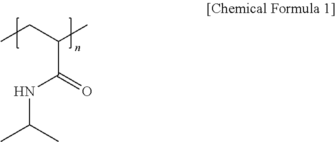

The temperature-sensitive polymer 132 described above may be grafted on the surface of the binder particle 131, and as a grafting method, both grafting-from and grafting-on may be used.

In emulsion polymerization of SBR, which may be the binder particle 131, by adding a N-isopropylacrylamide (NIPAM) monomer at the end of reaction, it may be synthesized by grafting-from on the surface of the SBR.

By adding a poly(N-isopropylacrylamide) (PNIPAM) polymer in a cross-linking process after synthesis of the SBR, which may be the binder particle 131, it may be synthesized by grafting-on on the surface of the SBR.

The binder 130 may be contained at 0.5 to 5 wt % with respect to a total weight of the negative electrode active material layer 120. The negative electrode active material 121 may be contained at 80 to 98 wt %, the conductive material may be contained at 0.2 to 10 wt %, and the functional additive may be contained at 0.5 to 5 wt %.

If a content of the binder 130 is less than a proposed content range(s), the effect of containing the binder 130 may not be expected, and if a content of the binder 130 is greater than the proposed content range(s), a content of the negative electrode active material 121 may be relatively reduced, thus reducing the specific capacity of the negative electrode and increasing the resistance of the cell.

A binder forming an electrode of a secondary battery may include a binder particle and a temperature-sensitive polymer grafted on a surface of the binder particle.

The temperature-sensitive polymer may be characterized in that hydrophilicity thereof becomes lower and a shape of a polymer chain shrinks, at a lower critical solution temperature (LCST) and/or over than at a temperature below the LCST.

The LCST of the temperature-sensitive polymer may be 30 to 80° C.

The LCST of the temperature-sensitive polymer may be 30 to 40° C.

The binder particle may be styrene-butadiene rubber (SBR), and the temperature-sensitive polymer may be poly-N-isopropylacrylamide.

A particle size of the binder particle may be 100 to 300 nm.

A negative electrode for a secondary battery may include a negative electrode base material and an active material layer coated on at least any one of both surfaces of the negative electrode base material and including a binder in which a temperature-sensitive polymer is grafted on a surface of a binder particle.

The active material layer may further include a conductive material and a functional additive, and the binder may be contained at 0.5 to 5 wt % with respect to a total weight of the active material layer.

The temperature-sensitive polymer may be characterized in that a shape of a polymer chain shrinks and a bonding force between the negative electrode active material and the conductive material, and a bonding force with the negative electrode base material increase, at a lower critical solution temperature (LCST) and/or over than at a temperature below the LCST.

The binder particle may be styrene-butadiene rubber (SBR), and the temperature-sensitive polymer may be poly-N-isopropylacrylamide.

In a lithium secondary battery including a positive electrode, a negative electrode, a separator, and an electrolyte, the negative electrode may include a negative electrode base material and an active material layer coated on at least any one of both surfaces of the negative electrode base material and including a binder in which a temperature-sensitive polymer is grafted on a surface of a binder particle.

The active material layer may further include a conductive material and a functional additive, and the binder may be contained at 0.5 to 5 wt % with respect to a total weight of the active material layer.

The temperature-sensitive polymer may be characterized in that a shape of a polymer chain shrinks and a bonding force between the negative electrode active material and the conductive material, and a bonding force with the negative electrode base material increase, at a lower critical solution temperature (LCST) and/or over than at a temperature below the LCST.

The binder particle may be styrene-butadiene rubber (SBR), and the temperature-sensitive polymer may be poly-N-isopropylacrylamide.

Although various examples of the present disclosure have been described with reference to the accompanying drawings, aspects of the present disclosure are not limited thereto. Accordingly, those of ordinary skill in the art may variously change and modify one or more features of the present disclosure within the scope without departing from the technical spirit of the claims to be described later.

What is claimed is:

1. A binder forming an electrode of a secondary battery, the electrode comprising:
a binder particle; and
a temperature-sensitive polymer grafted on a surface of the binder particle.

2. The binder of claim 1, wherein the binder particle comprises styrene-butadiene rubber (SBR), and wherein the temperature-sensitive polymer comprises poly-N-isopropylacrylamide.

3. The binder of claim 1, wherein, at a lower critical solution temperature (LCST), hydrophilicity of the temperature-sensitive polymer becomes lower and a shape of a polymer chain of the temperature-sensitive polymer shrinks.

4. The binder of claim 3, wherein the LCST of the temperature-sensitive polymer is a temperature in a range of 30° C. to 80° C.

5. The binder of claim 3, wherein the LCST of the temperature-sensitive polymer is a temperature in a range of 30° C. to 40° C.

6. The binder of claim 1, wherein a particle size of the binder particle is in a range of 100 nm to 300 nm.

7. A negative electrode for a secondary battery, the negative electrode comprising:
a negative electrode base material; and
an active material layer coated on at least one surface of the negative electrode base material, wherein the active material layer comprises a binder comprising:
a binder particle; and
a temperature-sensitive polymer grafted on a surface of the binder particle.

8. The negative electrode of claim 7, wherein the active material layer further comprises a negative electrode active material, a conductive material, and a functional additive, and
the binder is contained at 0.5 to 5 wt % with respect to a total weight of the active material layer.

9. The negative electrode of claim 7, wherein the binder particle comprises styrene-butadiene rubber (SBR), and
the temperature-sensitive polymer comprises poly-N-isopropylacrylamide.

10. The negative electrode of claim 8, wherein, at a lower critical solution temperature (LCST):
a shape of a polymer chain of the temperature-sensitive polymer shrinks;
a bonding force between the negative electrode active material of the active material layer and a conductive material of the active material layer increases; and
a bonding force between the active material layer and the negative electrode base material increases.

11. A secondary battery comprising:
a positive electrode;
a separator;
an electrolyte; and
a negative electrode comprising:
a negative electrode base material; and
an active material layer coated on at least one surface of the negative electrode base material, wherein the active material layer comprises a binder comprising:
a binder particle; and
a temperature-sensitive polymer grafted on a surface of the binder particle.

12. The secondary battery of claim 11, wherein the active material layer further comprises a negative electrode active material, a conductive material, and a functional additive, and
the binder is contained at 0.5 to 5 wt % with respect to a total weight of the active material layer.

13. The secondary battery of claim 11, wherein the binder particle comprises styrene-butadiene rubber (SBR), and
the temperature-sensitive polymer comprises poly-N-isopropylacrylamide.

14. The secondary battery of claim 12, wherein, at a lower critical solution temperature (LCST):
a shape of a polymer chain of the temperature-sensitive polymer shrinks;
a bonding force between the negative electrode active material of the active material layer and a conductive material of the active material layer increases; and
a bonding force between the active material layer and the negative electrode base material increases.
